(19) United States
(12) Patent Application Publication
(10) Pub. No.: US 2013/0118460 A1
(43) Pub. Date: May 16, 2013

(54) Plate Assembly for Positive Crankcase Ventilation System

(71) Applicant: Sean Christopher Lockard, Cumberland, MD (US)

(72) Inventor: Sean Christopher Lockard, Cumberland, MD (US)

(73) Assignee: STASIS, INC., Summit Point, WV (US)

(21) Appl. No.: 13/356,635

(22) Filed: Jan. 23, 2012

Related U.S. Application Data
(63) Continuation-in-part of application No. 13/298,245, filed on Nov. 16, 2011.

(51) Int. Cl. F02B 25/06

(52) U.S. Cl. 123/574

(57) ABSTRACT

A positive crankcase ventilation (PCV) plate system is disclosed that provides for expanded operation on a vehicle engine. The PCV system, in an embodiment, comprises a PCV plate, cap, and adapter plug. The PCV plate may have three orifices that may align with and securely mount over ports on an engine valve cover. One orifice on the PCV plate may be fitted with the adapter plug to allow attachment of a block breather hose or other hose, while two other orifices may allow attachment of the cap or catch cans. The cap may be installed over two orifices on the PCV plate. Crankcase vapors, for example, may then enter one orifice, flow through the cap and out through a second orifice, allowing the vacuum from a turbocharger, for example, to draw crankcase vapors into the intake manifold.

### CROSS-REFERENCE TO RELATED APPLICATIONS

The present patent application is a continuation-in-part of co-pending U.S. patent application Ser. No. 13/298,245, filed Nov. 16, 2011, which is incorporated herein by reference.

### STATEMENT REGARDING FEDERALLY SPONSORED RESEARCH

Not Applicable

### THE NAMES OF THE PARTIES TO A JOINT RESEARCH AGREEMENT

Not Applicable

### INCORPORATION-BY-REFERENCE OF MATERIAL ON DISC

Not Applicable

### BACKGROUND

1. Technical Field of the Invention

This invention pertains generally to a plate assembly for use in positive crankcase ventilation (PCV) systems of motor vehicles. More specifically, the invention pertains to a PCV plate assembly that may include, in an embodiment, a PCV plate, cap, and adapter plug, allowing expanded operation of the PCV system on a turbocharged, supercharged, or naturally aspirated motor vehicle engine.

2. Background of the Invention

An internal combustion engine typically includes one or more cylinders that include combustion chambers where a fuel-air mixture is burned to cause movement of a piston, and a crankcase, which contains a crankshaft driven by the one or more pistons. The combustion chamber resides on one side of the pistons and the crankcase, which is full of oil, resides on the other side. A set of rings on the pistons works to keep oil out of the combustion chamber and fuel and air out of the oil. During operation, however, the pressure of combustion within the combustion chamber forces gases to leak past the piston rings and into the crankcase. These leaked gases, referred to as “blow-by,” contain unburned fuel, moisture, acids and other undesirable byproducts of the combustion process. Consequently, the blow-by can dilute and contaminate the engine oil, cause corrosion of critical engine parts, and contribute to a buildup of sludge. Furthermore, at high engine speeds, the blow-by can increase the pressure within the crankcase, leading to oil leakage from sealed engine surfaces and reduced engine performance (increased resistance during the piston power stroke).

Early solutions to this problem allowed the gases to escape directly into the environment. In the early 1960's, however, the EPA deemed blow-by to be hazardous to the environment and decided that it should not be allowed to freely escape. The automobile industry started fitting engines with positive crankcase ventilation (PCV) systems to ensure that the gas was contained within vehicles.

In a naturally aspirated engine, the PCV system connects the crankcase to the intake manifold via a breather hose. As a result, engine vacuum in the intake manifold is used to draw a flow of air through the crankcase to entrain blow-by. The air with entrained blow-by is directed by the PCV system into the engine air intake to be re-burned during the combustion process in the engine.

In a typical engine, vacuum is generated as a result of the position of a throttle plate in a throttle body or carburetor and varies in an inverse relationship to the power output of the engine. The power produced is a function of both the torque that the engine is producing and the speed at which the engine is running. Thus, high engine vacuum occurs when (a) the engine is operating at an idle condition, with the throttle plate nearly closed, and the engine running essentially unloaded or (b) the throttle plate is at its lowest opening, and the engine is being motored by an inertia load, and receiving rather than producing power (engine braking in a vehicle). The lowest engine vacuum occurs when the engine is operating at a wide-open throttle condition and producing maximum power. Between idle and wide-open throttle, the engine vacuum drops as a function of how widely the throttle has been opened. Because of this variable vacuum, the PCV system allows blow-by to collect within the crankcase under conditions of low engine vacuum and may actually pull oil out of the crankcase under high engine vacuum.

Oil that is pulled out of the crankcase coats everything in its path as it makes its way back to the combustion chamber. Once back in the combustion chamber, this oil is burned, releasing undesirable gases into the atmosphere. Furthermore, when the tiny particles of dust and dirt that make it past the air filter come in contact with that oil, they bond together, making a thick sludge.

To solve these problems, many PCV systems include a valve which regulates the flow of blow-by by allowing more flow at high speed than at low speed, and acts as a system shutoff in case of engine backfire (pressure at intake manifold is higher than pressure in the crankcase) to prevent an explosion in the crankcase. Additionally, some PCV systems use an oil separator or “catch can”, which traps moisture and oil droplets before being drawn into the intake manifold.

The operation of a turbocharger in a turbocharged engine is similar to that of an engine running with wide open throttle. A compressor draws in ambient air and compresses it before it enters the intake manifold at increased pressure. This results in a greater mass of air entering the cylinders on each intake stroke. As such, turbocharged vehicles have significant amounts of blow-by due to the large pressure created inside the cylinders by this “injected” air. Furthermore, the intake manifold's pressure is frequently higher than that of the crankcase. PCV systems in these vehicles can be routed to draw a vacuum from the turbine of the turbocharger system when engine speed or torque is proportional to the vacuum available for blow-by draw.

The PCV systems currently known in the art use various ports on the crankcase to achieve the aforementioned benefits. Such systems attach to these ports and use them in a very specific manner, such that each is designated for a specific purpose and does not allow swapping-out of components (valve, breather hose, catch can, etc.). If an automobile owner wishes to upgrade his or her engine by adding a turbocharger, or improve emissions by adding a catch can, such is not possible without changing the entire PCV system.

Thus, there remains a need in the art for a PCV system that allows interchange of various components and thus expanded operation.

### SUMMARY

In one embodiment, a positive crankcase ventilation system includes: a positive crankcase ventilation plate including at least two orifices; a cap including at least two apertures and an opening extending between the at least two apertures, the cap for placement against the PCV plate such that at least two of the at least two apertures are aligned with at least two of the at least two PCV plate orifices; and an adapter plug to connect to the positive crankcase ventilation plate.

In another embodiment, a positive crankcase ventilation (PCV) system includes: a PCV plate including a first PCV plate side, a second PCV plate side, a first PCV plate orifice, a second PCV plate orifice, and a third PCV plate orifice; a cap to be positioned against the PCV plate, the cap including a first cap side, a second cap side, a first cap aperture, a second cap aperture, and an opening extending between the first and second cap apertures, the first and second cap apertures to mate at the second cap side with the first and second PCV plate orifices at the first PCV plate side; and an adapter plug including a first end portion, a second end portion, and a passage, the passage extending from the first end portion to the second end portion, the second end portion of the adapter plug to at least partially extend into the third PCV plate orifice to attach the adapter plug to the PCV plate.

In another embodiment, a method of ventilating a crankcase includes: attaching a crankcase ventilation plate including at least two orifices over an engine opening; and placing a cap including at least two apertures and an opening between two of the at least two cap apertures on the positive crankcase ventilation plate such that at least two of the cap apertures are aligned with at least two of the crankcase ventilation plate orifices and such that two of the at least two orifices of the crankcase ventilation plate, the two of the at least two apertures of the cap, and the opening are in fluid communication.

Other embodiments, which may include one or more parts of the aforementioned method or systems or other parts, are also contemplated, and may thus have a broader or different scope than the aforementioned method and systems. Thus, the embodiments in this Summary of the Invention are mere examples, and are not intended to limit or define the scope of the invention or claims.

### BRIEF DESCRIPTION OF THE DRAWINGS

Aspects, features, benefits and advantages of the embodiments herein will be apparent with regard to the following description, appended claims, and accompanying drawings. In the following figures, like numerals represent like features in the various views. It is to be noted that features and components in these drawings, illustrating the views of embodiments of the present invention, unless stated to be otherwise, are not necessarily drawn to scale.

FIG. 1 is an external perspective view of an embodiment of a PCV system of the present invention;

FIG. 2 is an external perspective view of an embodiment of the PCV system of the present invention;

FIG. 3 is an external top view depicting an embodiment of a PCV plate of the PCV system of the present invention;

FIG. 4 is an external bottom view depicting an embodiment of the PCV plate of the PCV system of the present invention;

FIG. 5a is an external side view depicting an embodiment of the PCV plate of the PCV system of the present invention;

FIG. 5b is a cross-sectional view of an embodiment of the PCV plate of the PCV system of the present invention along A-A in FIG. 5a;

FIG. 6 is an external top view depicting an embodiment of a link plate of the PCV system of the present invention;

FIG. 7 is an external bottom view and a cross-sectional view along A-A of an embodiment of the link plate of the PCV system of the present invention;

FIG. 8 is an external top view depicting an embodiment of the link plate gasket of the PCV system of the present invention;

FIG. 9a is an external side view depicting an embodiment of an adapter plug of the PCV system of the present invention;

FIG. 9b is a cross-sectional view of an embodiment of the adapter plug of the PCV system of the present invention along A-A in FIG. 9a;

FIG. 10 is an external side view depicting an embodiment of a link plate plug of the PCV system of the present invention;

FIG. 11a is an external top view depicting an embodiment of the link plate plug of the PCV system of the present invention;

FIG. 11b is a cross-sectional view depicting an embodiment of the link plate plug of the PCV system of the present invention along A-A in FIG. 11a;

FIG. 12 is an external perspective view of an embodiment of a PCV system of the present invention;

FIG. 13 is an external perspective view of an embodiment of the PCV system of the present invention;

FIG. 14 is an external perspective view of an embodiment of a PCV plate of the PCV system of the present invention;

FIG. 15a is an external top view of an embodiment of a PCV plate of the PCV system of the present invention;

FIG. 15b is an external end view of an embodiment of a PCV plate of the PCV system of the present invention;

FIG. 16 is an external bottom view of an embodiment of a PCV plate of the PCV system of the present invention;

FIG. 17 is an external side view of an embodiment of the PCV plate of the PCV system of the present invention;

FIG. 18 is an external perspective view of an embodiment of a cap of the PCV system of the present invention;

FIG. 19 is an external perspective view of an embodiment of a cap of the PCV system of the present invention;

FIG. 20a is an external top view of an embodiment of a cap of the PCV system of the present invention;

FIG. 20b is an external side view of an embodiment of a cap of the PCV system of the present invention;

FIG. 21 a is an external bottom view of an embodiment of a cap of the PCV system of the present invention;

FIG. 21b is an external end view of an embodiment of a cap of the PCV system of the present invention;

FIG. 22a is an external side view depicting an embodiment of an adapter plug of the PCV system of the present invention; and

FIG. 22b is a cross-sectional view of an embodiment of the adapter plug of the PCV system of the present invention along A-A in FIG. 22a.

### DETAILED DESCRIPTION

In the following description, the present invention is set forth in the context of various alternative embodiments and implementations involving positive crankcase ventilation (PCV) plates for motor vehicles, and more specifically to a PCV plate system comprising, in an embodiment, one or more of a PCV plate, cap, and an adapter plug, which allow expanded operation of the PCV system on a turbocharged or other motor vehicle engine.

It will be appreciated that these embodiments and implementations are illustrative and various aspects of the invention may have applicability beyond the specifically described contexts. Furthermore, it is to be understood that these embodiments and implementations are not limited to the particular components, methodologies, or protocols described, as these may vary. The terminology used in the following description is for the purpose of illustrating the particular versions or embodiments only, and is not intended to limit their scope in the present disclosure, which will be limited only by the appended claims.

Throughout the specification, reference to “one embodiment,” “an embodiment,” or “some embodiments” means that a particular described feature, structure, or characteristic is included in at least one embodiment. Thus appearances of the phrases “in one embodiment,” “in an embodiment,” or “in some embodiments” in various places throughout this specification are not necessarily all referring to the same embodiment. Those skilled in the art will recognize that the various embodiments can be practiced without one or more of the specific details or with other methods, components, materials, etc. In other instances, well-known structures, materials, or operations are not shown or not described in detail to avoid obscuring aspects of the embodiments.

“Optional” or “optionally” means that the subsequently described event or circumstance may or may not occur, and that the description includes instances where the event occurs and instances where it does not. In addition, the word “comprising” as used herein means “including, but not limited to”. Throughout the specification of the application, various terms are used such as “primary”, “secondary”, “first”, “second”, and the like. These terms are words of convenience in order to distinguish between different elements, and such terms are not intended to be limiting as to how the different elements may be used.

It must also be noted that as used herein and in the appended claims, the singular forms “a”, “an”, and “the” include the plural reference unless the context clearly dictates otherwise. Thus, for example, reference to a “plug” is a reference to one or more plugs and equivalents thereof known to those skilled in the art, and so forth. Unless defined otherwise, all technical and scientific terms used herein have the same meanings as commonly understood by one of ordinary skill in the art.

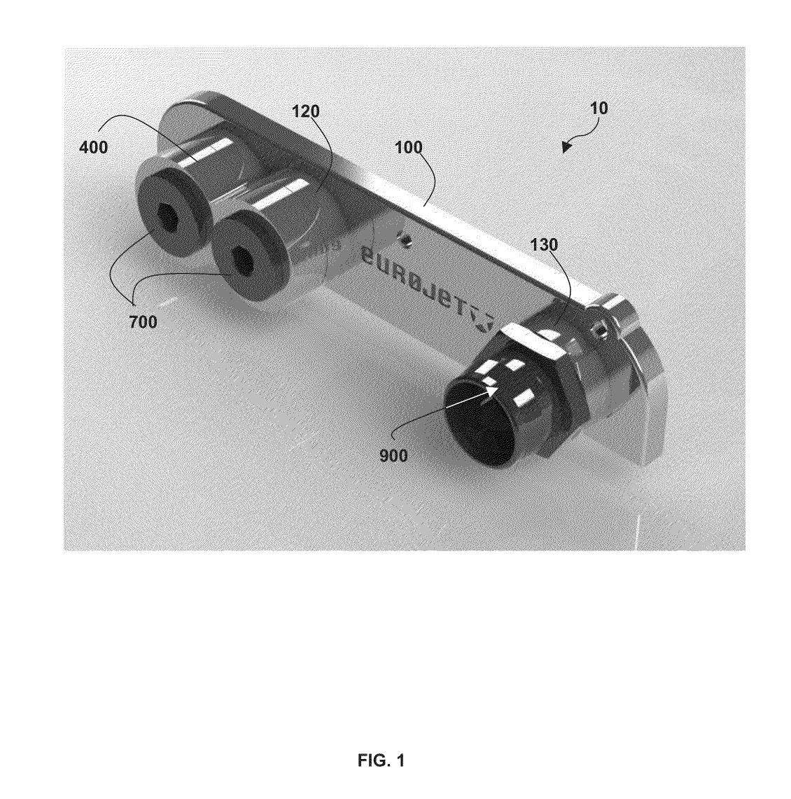

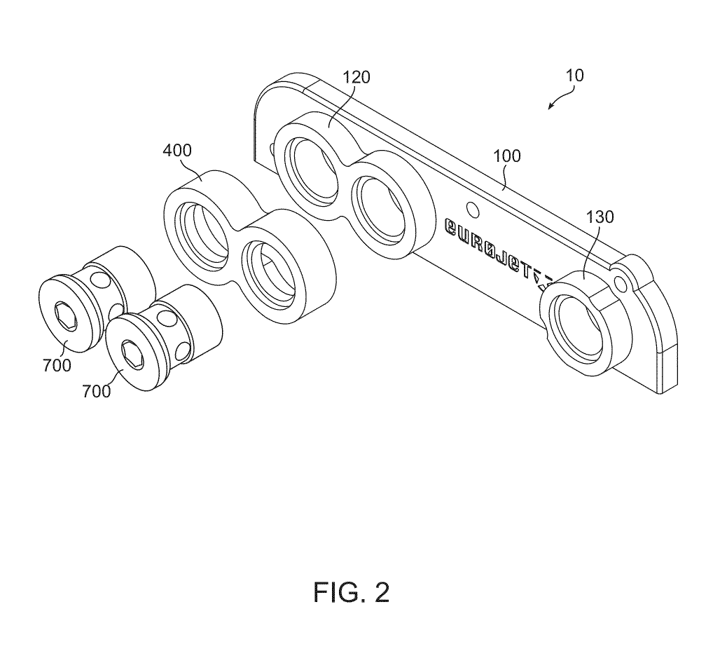

Referring now to the drawings, an embodiment of the PCV system of the present invention is shown in FIG. 1 and FIG. 2 and designated by the reference numeral 10. The PCV system 10 includes a PCV plate 100, a link plate 400, one or more, such as two, link plate plugs 700, and an adapter plug 900. The PCV plate 100 may include raised portions 120 and 130 that define openings, orifices A, B, and C, that may allow for connection to various components of the PCV system 10. For example, the opening, orifice C, defined by the raised portion 130, when fitted with the adapter plug 900, may allow for connection to a block breather hose. Additionally, one or more orifices, such as orifices A, B, and C defined by raised portions 120 and 130 may allow for connection of the PCV system 10 and PCV plate 100 to catch can systems, various hoses, or valves, or may be blocked with plugs. The PCV plate 100 with the link plate 400 and link plate plugs 700 installed may function to draw crankcase vapors into the intake tract using the vacuum from an intake manifold or a turbocharger. Thus, embodiments of the PCV system 10 of the present invention provide for expanded operation by allowing various components to be swapped in or out with ease.

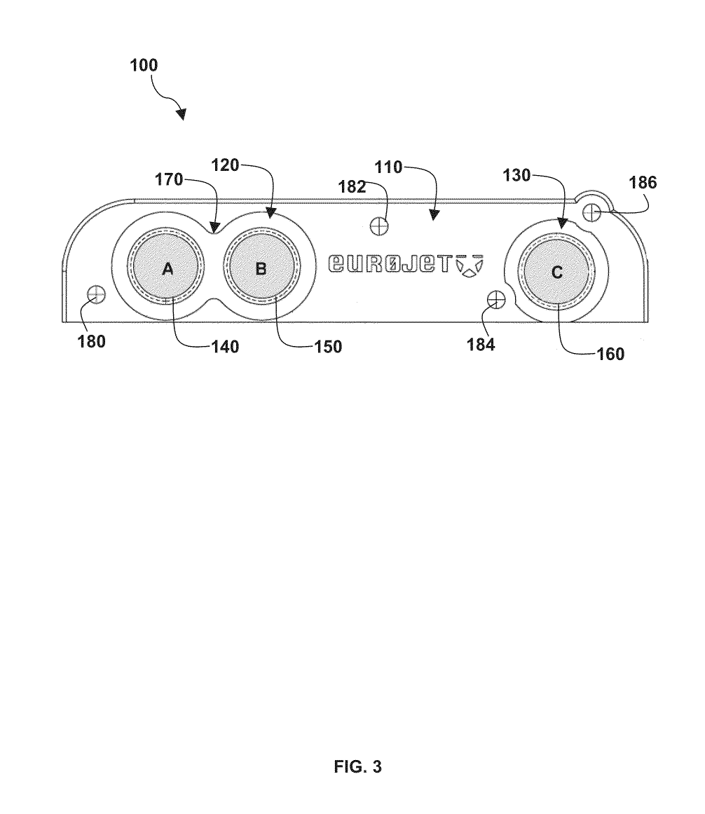

The PCV plate 100 may be a machined aluminum plate or may be composed of any sturdy heat-resistant material known in the art. As shown in FIG. 3, an embodiment of the PCV plate may have a first or top side 110 comprising the raised portion 120 which defines first and second orifices A and B, respectively, and the raised portion 130 which defines a third orifice C. While each orifice A, B, and C is shown to be cylindrical, any other shape may be used. The raised portion 120 may further include an indent 170 in the raised portion 120 that partially separates and defines first and second orifices A and B. Such an indent 170 may provide for reduced use of materials on the first side of PCV plate 100. However, other shapes for the raised portion 120 may be substituted and are within the scope of the present invention.

First, second, and third orifices A, B and C, respectively, have inner walls 140, 150 and 160, respectively. Each inner wall may be threaded in an embodiment. Thus, a portion or all of each inner wall may have grooves machined to provide threads allowing for attachment of various components. In some embodiments, the grooves are machined as 7/8-14 threads, although any diameter and number of threads may be used. In embodiments, the first and second PCV plate orifices A and B may be threaded within a bottom portion of the interior of each orifice, wherein the bottom portion resides closest to the second side 210 of the PCV plate 100. These threads may be adapted to engage threads on the link plate plug 700 described herein, such as threads on a connecting portion 770 of the link plate plug 700.

In embodiments, the first, second and third PCV plate orifices A, B and C, respectively, may mate with like openings on the valve cover of an engine, such as a turbocharged, supercharged, or naturally aspirated automobile engine.

The PCV plate 100 may also include attachment points (180, 182, 184, and 186) which allow the PCV plate to be securely installed over ports on a valve case. While four attachment points are shown, any number that provides for secure connection may be used. Each attachment point may be a small hole allowing a bolt access to an area on an engine valve cover, thus providing secure attachment of the PCV plate 100 on the valve cover. While bolt holes are shown, screws or any other means of secure attachment known in the art is also within the scope of the present invention. For example, in various embodiments, the PCV plate 100 includes at least one screw extending through an attachment point (180, 182, 184 and 186) that is a hole in the PCV plate 100 and into the valve cover. In one such embodiment, the attachment means includes four screws extending through four holes in the PCV plate 100 and into the engine valve cover to mount the PCV plate 100 to the valve cover.

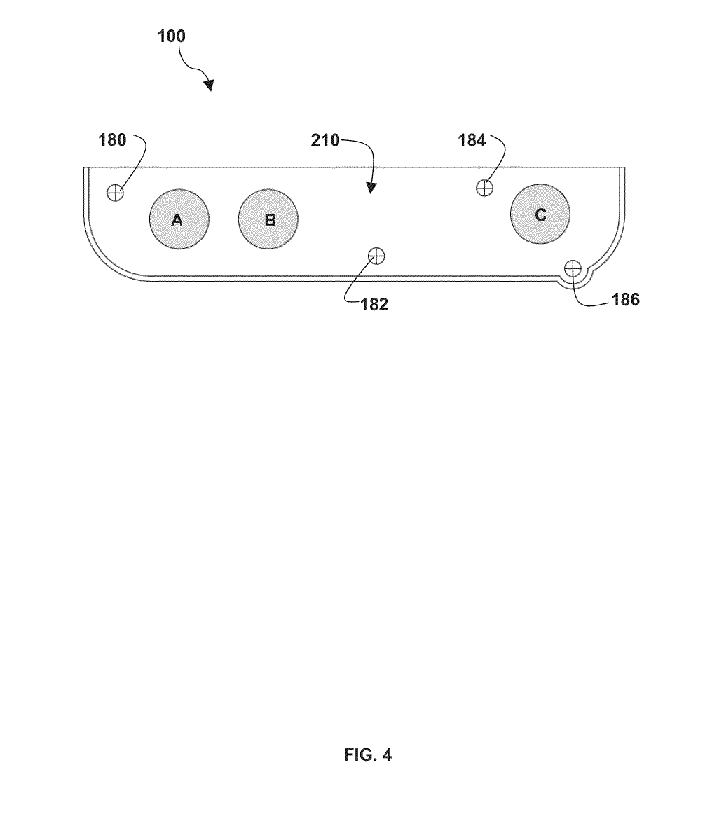

A second or bottom side 210 of an embodiment of the PCV plate 100 is shown in FIG. 4. Also shown are orifices A, B and C and attachment points 180, 182, 184, and 186. As illustrated, this second side 210 does not include any raised edges in this embodiment. However, any configuration allowing secure attachment to an area on a valve cover or other relevant engine part is also within the scope of the present invention.

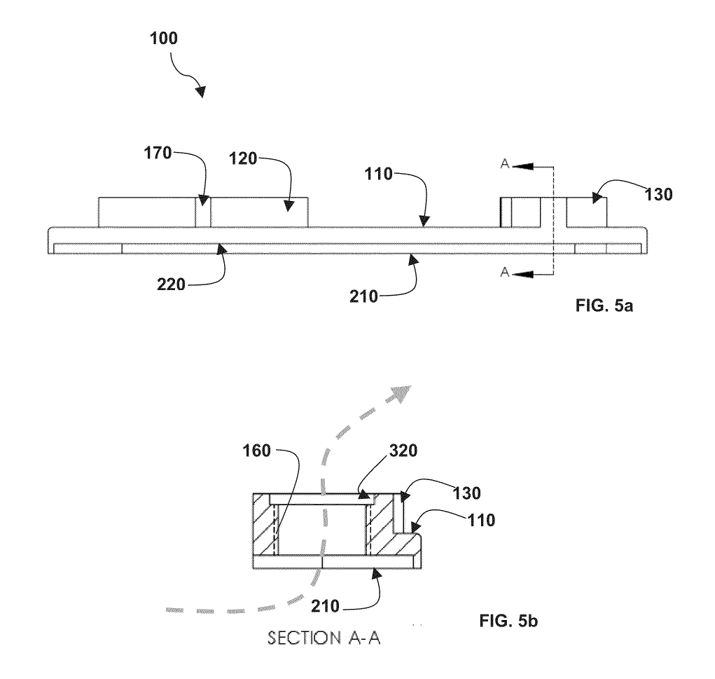

A side view of an embodiment of the PVC plate 100 is illustrated in FIG. 5a and a cross-sectional view of the PCV plate along A-A in FIG. 5a is shown in FIG. 5b. As illustrated, the first or top side 110 is shown with raised portions 120 and 130, while the second or bottom side 210 is shown to have no raised portions. Also shown is indent 170 as discussed in reference to FIG. 3. Section A-A through third orifice C shows the inner wall 160 having grooves machined and thus being threaded to allow for attachment of various components. For example, those threads may be adapted to engage threads 950 on the second end portion 920 of the adapter plug 900 described herein. The inner wall 160 of the orifice C of the PCV plate 100 may be threaded such that the threads are located within a bottom portion of the inner wall 160 nearer the bottom side 210 of the PCV plate 100. Alternatively, the inner wall 160 may be threaded such that an additional part, another part, or the entirety of the inner wall 160 includes threads.

The third orifice C is also shown to have a seat 320 indentation adjacent to the first side 110 of the PCV plate 100 in this embodiment. The seat 320 may be defined within the top portion of the interior of the orifice C. This seat 320 may allow clearance for the adapter plug 900 described herein or other apparatus to be inserted into the orifice C and may allow for use of a gasket (not shown), which may be placed in the seat 320 to provide a seal between the PCV plate 100 and the adapter plug 900 or other apparatus. Orifices A and B may or may not include seats, like seat 320. Also depicted in the cross section A-A illustrated in FIG. 5b are the first or top side 110, second or bottom side 210, and the raised portion 130 of the PCV plate 100.

A crankcase seat 220 is also provided in the embodiment illustrated in FIGS. 5a and 5b. The crankcase seat 220 may include an indentation in which a gasket may be placed or which may be included for various purposes, including reduction in material and weight.

The PCV plate 100 may allow for attachment of a block breather hose at the third orifice C, and may also provide for attachment of other components at first and second orifices A and B such as, but not limited to, recirculating and vent to atmosphere catch can systems.

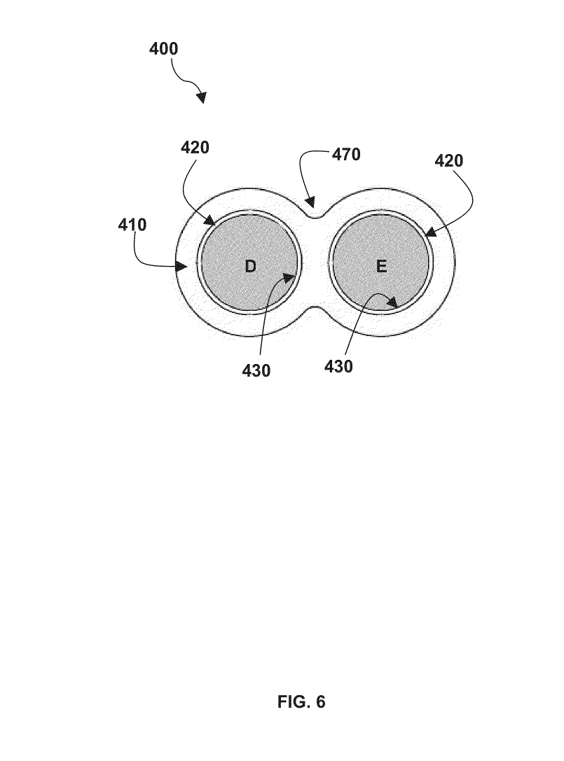

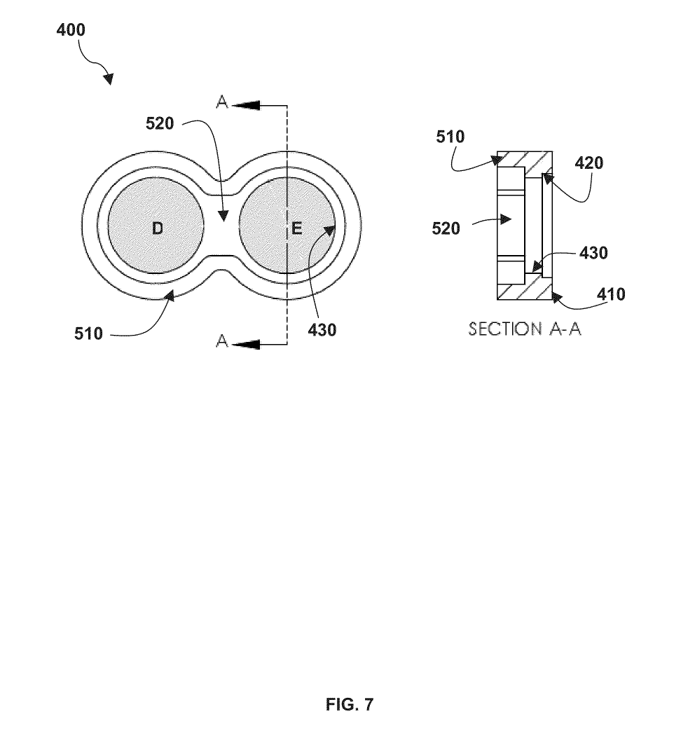

An embodiment of the link plate 400 is shown in FIG. 6 and FIG. 7. The link plate 400 may be a machined aluminum plate or may be composed of any sturdy heat-resistant material. The link plate 400 includes a first or top side 410 and a second or bottom side 510. Also shown are link plate orifices D and E. Link plate orifices D and E can be coaxially aligned with PCV plate orifices A and B, respectively, when the second link plate side 510 is mated with the first PCV plate side 110 of the PCV plate 100. Thus, the first and second link plate orifices D and E may mate at the second link plate side 510 with the first and second PCV plate orifices A and B at the first PCV plate side 110. While each orifice is shown to be cylindrical, any other shape known in the art may be used.

The link plate 400 is shown in FIG. 6 to have an indent 470. Such an indent 470 may provide for reduced use of materials. However, other shapes may be envisioned and are within the scope of the present invention.

The first or top side 410 of the link plate 400 may include one or more link plate seats 420, each defined within a top or other portion of the interior walls 430 of the orifices D and E, wherein the top portion resides closest to the first or top side 410 of the link plate 400. Each link plate seat 420, which may be an indent in an embodiment, may be adapted to receive at least part of a gasket and thus provide for a seal when one or more link plate plugs 700 are installed at least partially within orifices D and/or E. Alternatively, link plate seats 420 may not be included, or may be included but not have gaskets adjacently positioned.

The second or bottom side 510 of the link plate 400 is shown to have an opening 520 extending between the first and second link plate orifices D and E to allow fluid, which may include gas and/or liquid, to flow between the first and second link plate orifices D and E.

In one embodiment, the link plate 400 is formed with the PCV plate 100 such that the link plate 400 and PCV plate 100 are both included in the PCV system 10 but are not separate parts.

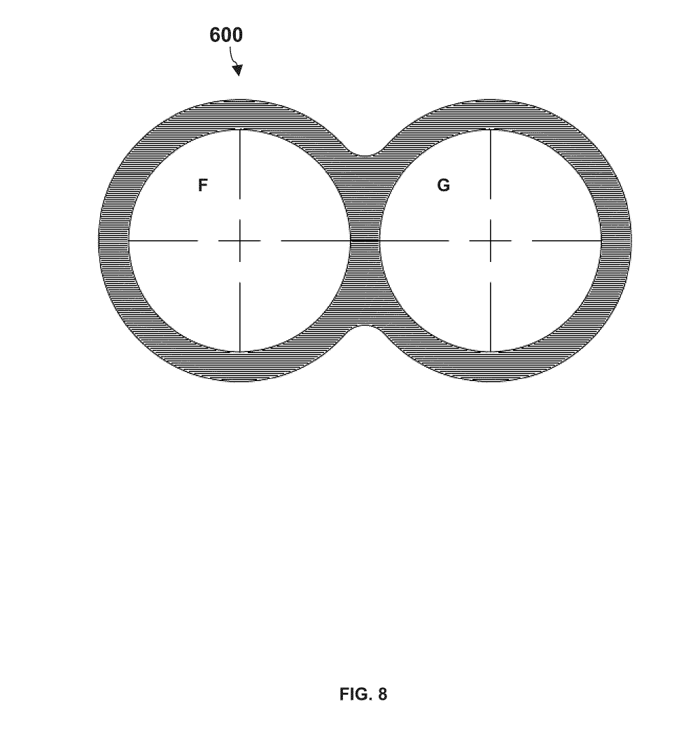

An embodiment of the link plate gasket 600 is shown in FIG. 8. The link plate gasket 600 may have a first gasket orifice F and a second gasket orifice G. The link plate gasket 600 may be positioned between the PCV plate 100 and link plate 400 with its orifices F and G respectively axially aligned with the orifices A and B of the PCV plate 100 and orifices D and E of the link plate 400. Orifices F and G may be of similar diameter and shape as orifices A and B of the PCV plate 100 and orifices D and E of the link plate 400 such that, when orifices A and B and orifices D and E are aligned with orifices F and G, respectively, the link plate gasket 600 may provide a seal between the link plate 400 and the PCV plate 100.

As described above, the second or bottom side 510 of the link plate 400 mates with the first or top side 110 of the PCV plate 100. The link plate gasket 600 may thus have a profile that matches that of the second or bottom side 510 and in an embodiment may exclude the region defined by opening 520, and thus some or all of its portion between orifices F and G, in order to allow for more free flow of fluid, which may include liquid and/or gas, through the region defined by the opening 520. Alternatively or in addition, the link plate gasket 600 may have a profile that matches that of raised portion 120 on the PCV plate 100 or otherwise as desired.

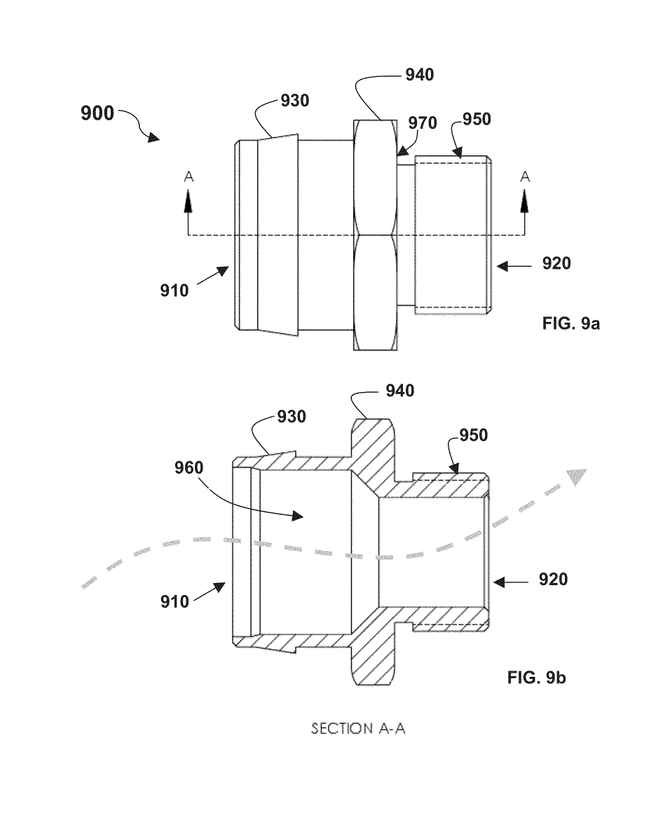

An embodiment of the adapter plug 900 is shown in FIGS. 9a and 9b. The adapter plug 900 may have an at least partially cylindrical body with a first end portion 910 including an exterior flange 930 and a second end portion 920 including exterior threads 950 or a differently shaped surface that permits attachment to another apparatus, such as the PCV plate 100, such as by having the second end portion 920 extend at least partially into orifice C. The exterior flange 930 may aid in connecting one or more hoses to the adapter plug 900 such as, but not limited to, a block breather hose in which crankcase fluids may be vented to the atmosphere or one or more hoses to a catch can into which crankcase fluids, including liquids and/or vapors, may be discharged. The threads 950 may be adapted to engage threads or a differently shaped surface on any of the PCV plate orifice inner walls 140, 150, and 160 of orifices A, B, and C, respectively. The adapter plug 900 may also include a passage 960 extending completely through the adapter plug 900. For example, in one embodiment, the passage 960 extends from the first end portion 910 to the second end portion 920.

The adapter plug 900 further comprises a portion extending between the first end portion 910 and second end portion 920 and defined by a raised portion 940, which has a peripheral hexagonal shape in one embodiment, or another grippable section to aid in installation of the adapter plug 900 in the PCV Plate 100 or another apparatus. This raised portion 940 may be adapted to receive a hexagonal or other wrench head around it in certain embodiments, for example, and thus provide a means to tighten the adapter plug 900 within one of the PCV plate 100 orifices A, B, and C. Additionally, the raised portion 940 may define an adapter seat 970 to receive a gasket adjacent thereto to aid in providing a seal when the plug 900 is installed in an orifice A, B, or C of the PCV plate 100. When installed in a PCV plate 100 orifice such as orifice C, for example, the adapter plug 900 may form a gas tight seal and, as described above, allow attachment of any of various hoses such as a block breather hose or another hose.

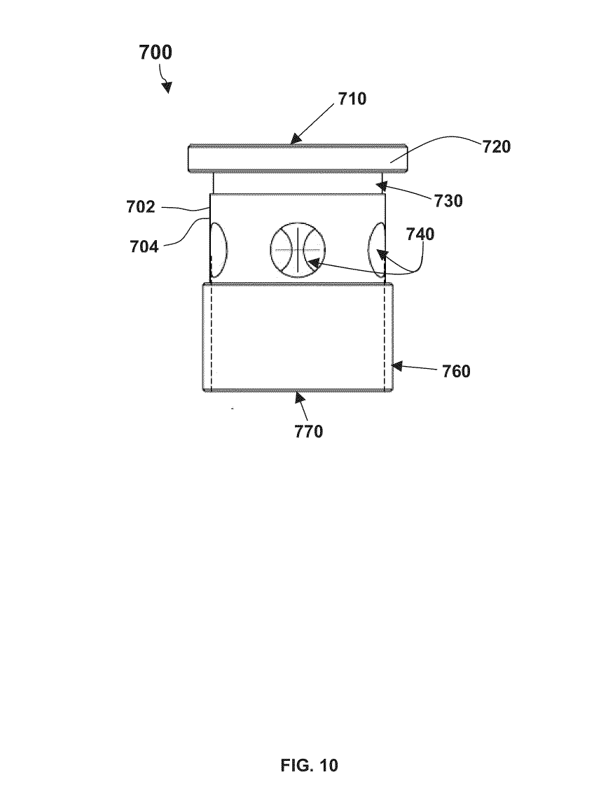

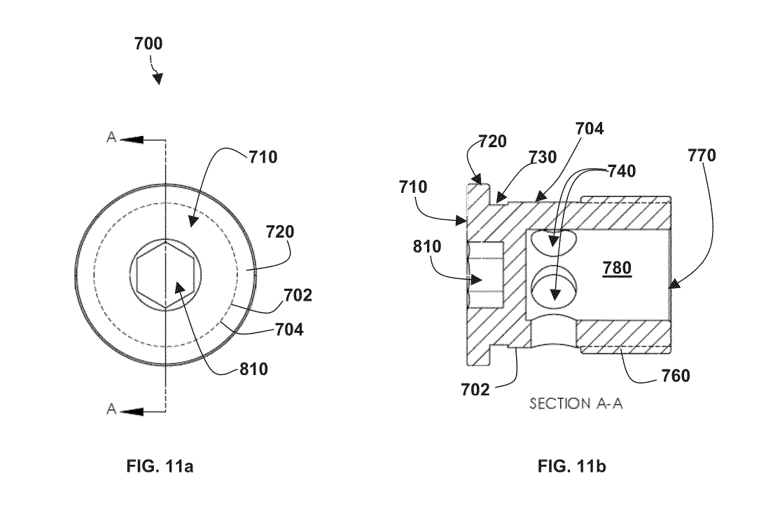

An embodiment of the link plate plug 700 is shown in FIG. 10, FIG. 11a, and FIG. 11b. That link plate plug 700 may have an at least partially cylindrical body 702 with an outer portion 710, a connecting portion 770, and a lateral portion 704 therebetween. The outer portion 710 may be coaxial with the lateral portion 704 and have a larger diameter than the lateral portion 704 such that the outer portion 710 extends past the perimeter of the lateral portion 704 to form a grippable rim 720. The rim 720 may be gripped, for example, by a hand or a pipe wrench. Other shapes, such as flat sides, which may be gripped by a wrench, could alternately be employed on the rim 720. The rim 720 of this embodiment seats against the first or top side 410 of the link plate 400 when the link plate plug 700 is threaded or otherwise installed in or through one of the link plate orifices A and B.

Adjacent to the rim 720 is an indent 730 in the lateral portion of the link plate plug 700. This indent 730 may be shaped to receive a gasket, and thus may aid in providing a seal when the link plate plug 700 is installed in the link plate 400 and PVC plate 100. The link plate plug 700 may extend through one of the link plate 400 orifices D and E and at least partially into one of the PCV plate 100 orifices A and B, respectively. In an embodiment, the link plate plug 700 is threaded, with exterior threads 760 on the connecting portion 770. The threads 760 may be adapted to engage threads of an inner wall 140 or 150 of an orifice A or B of the PCV plate 100 to secure the link plate plug 700 through the link plate 400 and into the PCV plate 100, such as shown in FIG. 1.

FIG. 11a and FIG. 11b also show that the link plate plug 700 may have a first bore which, in an embodiment, is a tightening bore 810 along a center axis in the outer portion 710. The tightening bore 810 may be shaped to receive a tool head, such as in a hexagon shape to receive a hexagonal head of a hex key or Allen wrench. The tightening bore 810 may be so shaped or otherwise shaped to facilitate any desired method to tighten the link plate plug 700 within the first or second link plate orifice D or E of the link plate 400 and/or the first or second PCV plate orifice A or B of the PCV plate 100 when, for example, two link plate plugs 700 are positioned in close proximity to one another, as when two link plate plugs 700 are positioned through link plate orifices D and E into PCV plate orifices A and B. In that case, it may be desirable to tighten and loosen one of the link plate plugs 700 using its internal tightening bore 810 while avoiding interference between the tightening/loosening tool and the second link plate plug 700.

Further, the link plate plug 700 may have a second bore, which may be a fluid flow bore 780 that may extend along the center axis of the link plate plug 700 or otherwise extend through the connecting portion 770 and into the lateral portion 704. Further, the link plate plug 700 may include at least one transverse bore 740 radially or otherwise extending into the lateral portion 704 of the link plate plug 700 such that the transverse bore 740 intersects with, and thus extends to, the fluid flow bore 780. In an embodiment, a plurality of transverse bores 740 are positioned about the perimeter of the lateral portion 704 and radially extend into the lateral portion 704 or otherwise through the cylindrical body 702 of the link plate plug 700 and into the fluid flow bore 780, thus intersecting the fluid flow bore 780. Such a configuration permits at least one of the transverse bores 740 to be in fluid communication with the opening 520 in the link plate 400 when the link plate plug 700 is secured through the link plate 400 and into the PCV plate 100 such as shown in FIG. 1. Thus, fluid is permitted to flow from the first link plate plug 700 through the link plate 400, regardless of the position of the link plate plug 700 when it is attached in or through the link plate 400.

In an embodiment in which the first link plate plug 700 is placed through the first orifice D of the link plate 400 and attached to the first orifice A of the PCV plate 100, and the second link plate plug 700 is placed through the second orifice E of the link plate 400 and attached to the second orifice B of the PCV plate 100, fluid, including liquid and/or gas, is permitted to flow from orifice A of the PCV plate 100 to orifice B of the PCV plate 100 through the first link plate plug 700, the link plate 400, and the second link plate plug 700. In that way, the versatile PCV plate 100 with the link plate 400 and a pair of link plate plugs 700 installed thereon can draw crankcase fluids, including vapors, into the intake tract.

The link plate 400 may be installed on the PCV plate 100 by aligning the second or bottom side 510 of the link plate 400 with the first or top side 110 of the PCV plate 100. The link plate gasket 600 may be disposed therebetween. This sandwich may be secured and sealed when link plate plugs 700 or adapter plugs 900 are inserted through the link plate 400 orifices D and E into PCV plate 100 orifices A and B. Thus, the link plate 400 orifices D and E may be mated with the PCV plate 100 orifices A and B, respectively. The exterior threads 760 on the link plate plugs 700 or adapter plugs 900 may engage the threads on a portion or all of the inner walls 140 and 150 (shown in FIG. 3) of the first and second PCV plate orifices A and B. A hex key may be used in the tightening bore 810 to tighten the link plate plug 700 or an adapter plug 900 may be fastened within the PCV plate orifices A and B. Further, a gasket that may reside on the link plate plug indent 730 may allow for a seal to be created between the link plate plug 700, the link plate 400, and the PCV plate 100.

When assembled with link plate plugs 700 in orifices A and B, the PCV system 10 provides a fluid channel that allows gases from an engine crankcase to enter one link plate plug 700, flow through the link plate 400 including through the opening 520, and exit through the second link plate plug 700. As such, the PCV system 10 may use vacuum from an intake manifold or a turbocharger to draw crankcase vapors into the intake manifold or at any point along the intake track.

Thus, it may be seen that embodiments of the present invention provide for PCV systems that allow for multiple modes of operation within one system including, but not limited to, stock style positive crankcase ventilation, catch can systems, and breather hose ventilation, which may be to the atmosphere.

In one embodiment, a first link plate plug 700 and second link plate plug 700 are placed through the link plate 400 orifices D and E, respectively, when the orifices D and E of the link plate 400 are aligned coaxially with the orifices A and B of the PCV plate 100. The first link plate plug 700 and second link plate plug 700 may then be fastened to one or both of the link plate 400 and the PCV plate 100. For example, in one embodiment, the PCV plate 100 orifices A and B are threaded to accept threads on the connecting portions 770 of the first link plate plug 700 and second link plate plug 700, respectively. The link plate 400 orifices D and E are unthreaded in this embodiment such that the lateral portions 704 of the first link plate plug 700 and second link plate plug 700 are positioned in the link plate 400 orifices D and E, respectively. In that way, fluids, including liquids and/or gasses, may flow through one of the PCV plate 100 orifices A and B and may also flow through one of the link plate 400 orifices D and E directly or indirectly, thereby entering the fluid flow bore 780 of one of the link plate plugs 700.

For example, the fluid, including liquid and/or gas, may flow through the PCV plate 100 orifice A and link plate 400 orifice D, thereby entering the fluid flow bore 780 of the first link plate plug 700. From the fluid flow bore 780 of the first link plate plug 700, the fluid may flow through one of the transverse bores 740 in the lateral portion 704 of the first link plate plug 700, through the opening 520 in the link plate 400, into one of the transverse bores 740 in the second link plate plug 700, and through the fluid flow bore 780 in the second link plate plug 700, and may directly or indirectly pass through one of the other link plate 400 orifices E and B.

As described herein, the PCV system 10 embodiments may be used to ventilate a crankcase. The PCV plate 100 having at least two orifices A and B and possibly the third orifice C may be attached over an engine opening. The link plate 400 with orifices D and E and opening 520 extending therebetween may be placed on the PCV plate 100 such that the orifices D and E coaxially align with the PCV plate orifices A and B. Two link plate plugs 700 may then each be attached to the PCV plate orifices A and B by being positioned through the link plate orifices D and E and extending at least partially into the orifices A and B. The link plate plugs 700 may be secured via mating threads on the link plate plugs 700 (threads 760) and orifices A and B of the PCV plate 100 (on inner walls 140 and 150). The link plate plugs 700, as described herein, may each include an outer portion 710, a connecting portion 770, and a lateral portion 704 extending therebetween. The link plate plugs 700 may each also include, as described herein, a fluid flow bore 780 extending through the connecting portion 770 into the lateral portion 704 and a plurality of transverse bores 740 extending from the fluid flow bore 780 through the lateral portion 704. Therefore, the fluid flow bore 780, at least one of the plurality of transverse bores 740, and the opening 520 in the link plate 400 are in fluid communication. As described herein, crankcase fluids including vapors may flow from orifice A of the PCV plate 100 to orifice B of the PCV plate 100 through the first link plate plug 700, the link plate 400, and the second link plate plug 700. In that way, the PCV system 10 can draw crankcase fluids, including vapors, into the intake tract.

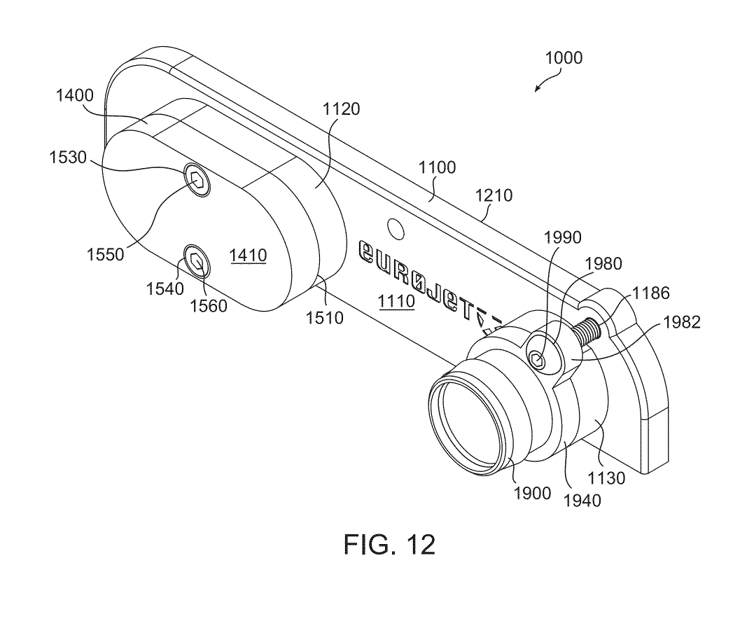

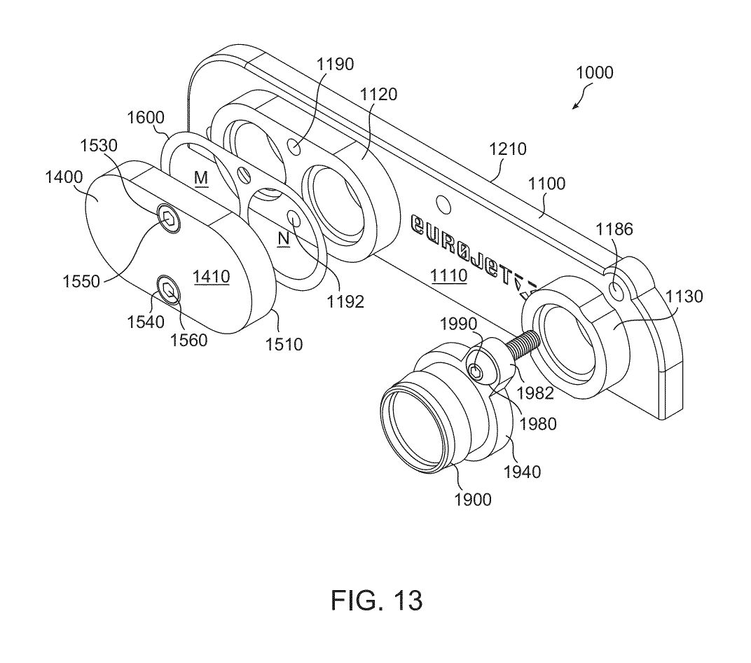

FIGS. 12 and 13 are external perspective views of another embodiment of a PCV system, PCV system 1000. Embodiments of the PCV system 1000 may include a PCV plate 1100 and adapter plug 1900 that may respectively correspond, at least in part, to the PCV plate 100 and adapter plug 900 described herein. The PCV system 1010 may, however, include a cap 1400 instead of both a link plate 400 and one or more link plate plugs 700.

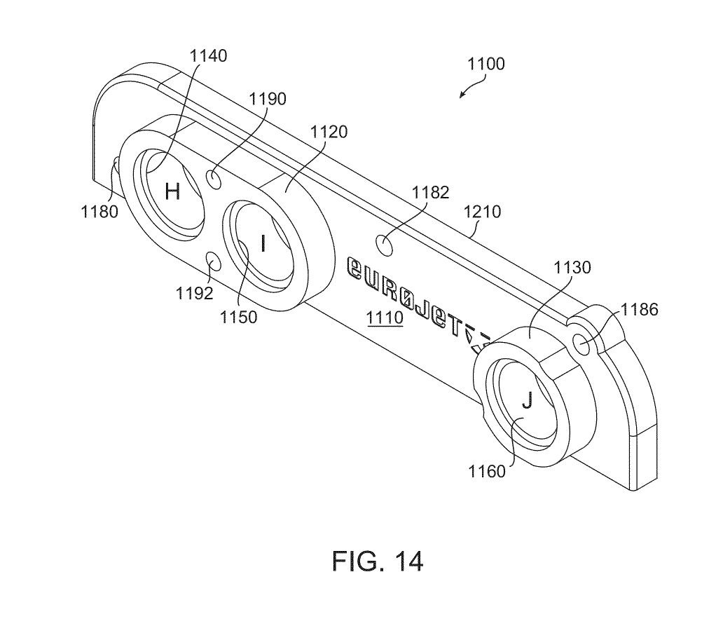

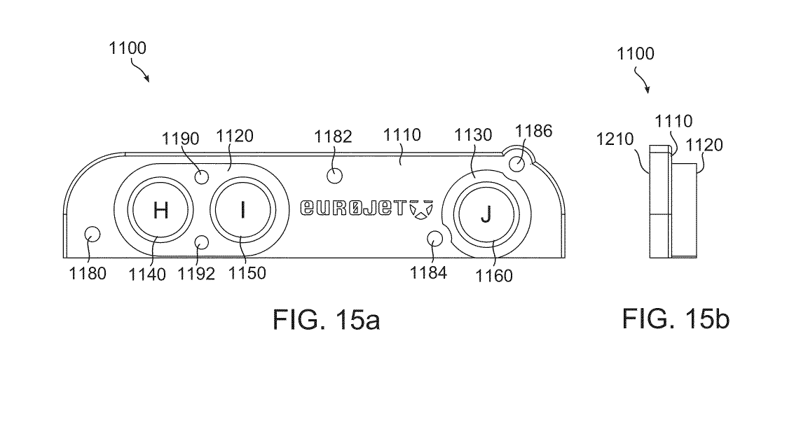

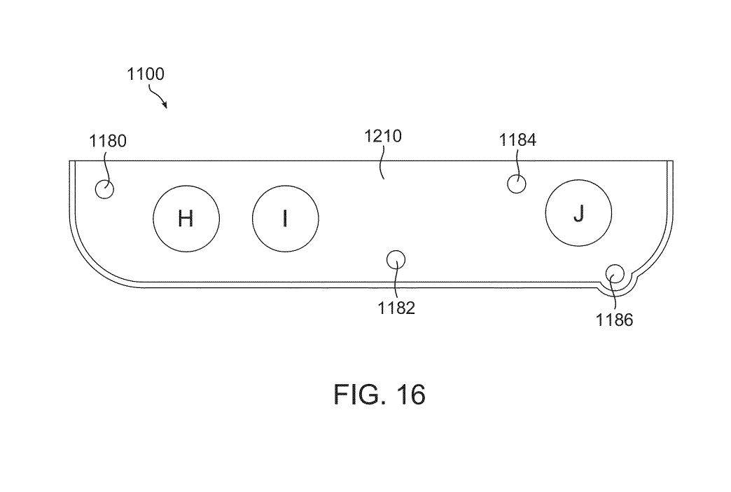

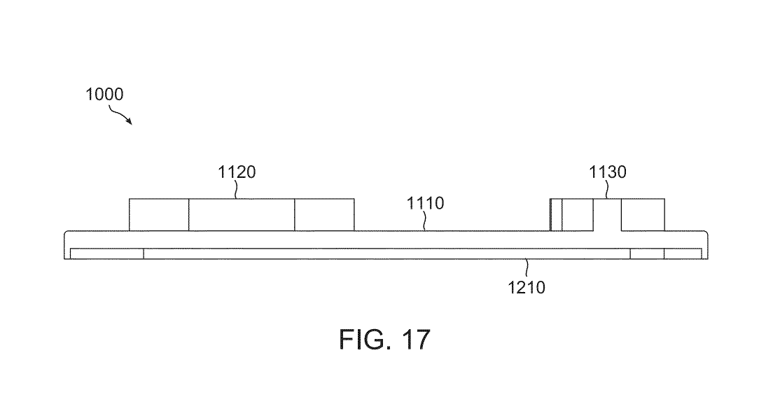

FIGS. 14, 15a, 15b, 16, and 17 are an external perspective view, external top view, external end view, external bottom view, and external side view of an embodiment of the PCV plate 1100 of the PCV system 1000 shown in FIGS. 12 and 13. The PCV plate 1100 may correspond to the PCV plate 100 such as described with respect to FIGS. 1-5b and herein. Thus, elements 1110, 1120, 1130, 1140, 1150, 1160, 1180, 1182, 1184, 1186, 1210, H, I, and J of the PCV plate 1100 may correspond to elements 110, 120, 130, 140, 150, 160, 180, 182, 184, 186, 210, A, B, and C of the PCV plate 1100, respectively, and the embodiments described herein with respect to those elements of the PCV plate 100 are also embodiments with respect to those elements of the PCV plate 1100. For example, the PCV plate 1100 may include a first or top side 1110, a second or bottom side 1210, and two or more orifices, such as three orifices H, I, and J having inner walls 1140, 1150, and 1160, respectively. As with the inner walls 140, 150, and 160 of the PCV plate 100 described above, the inner walls 1140, 1150, and 1160 may be threaded. Likewise, the first and second PCV plate 1100 orifices H and I may be defined by a raised portion 1120 on the first PCV plate side 1110, and the third PCV plate 1100 orifice J, if included, may be defined by another raised portion 1130 on the first PCV plate side 1110. The first, second, and third orifices H, I, and J may mate with like openings on a valve cover of an engine, such as a turbocharged, supercharged, or naturally aspirated automobile engine. The two or more orifices of the PCV system 1000, such as orifices H, I, and J, may, for example, allow for connection of the PCV plate 1100 and PCV system 1000 to catch can systems, various hoses, or valves, or may be blocked with plugs.

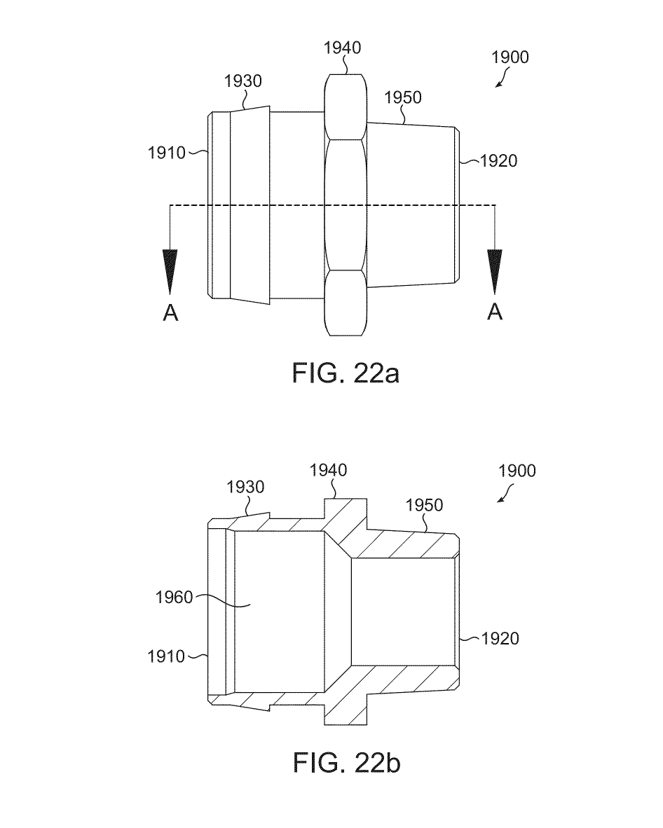

The PCV plate 1100 may also have differences in some embodiments, such as described herein. For example, the raised portion 1120 of the PCV plate 1100 may not include an indent such as the indent 170 of the raised portion 120 of the PCV plate 100. Additionally, the PCV plate 1100 may include other attachment points, such as the PCV plate 1100 holes 1190 and 1192 in the raised portion 1120, by which the cap 1400 may be attached to the PCV plate 1100 by bolt or screw, for example, as described below. Additionally, the attachment points 1184 and 1186 may allow attachment of the PCV plate 1100 to a valve cover of an engine, as with attachment points 184 and 186 of the PCV plate 100, and the attachment point 1186 and possibly also the attachment point 1184 may also secure the adapter plug 1900 to the PCV plate 1100 as described below with respect to FIGS. 22a and 22b.

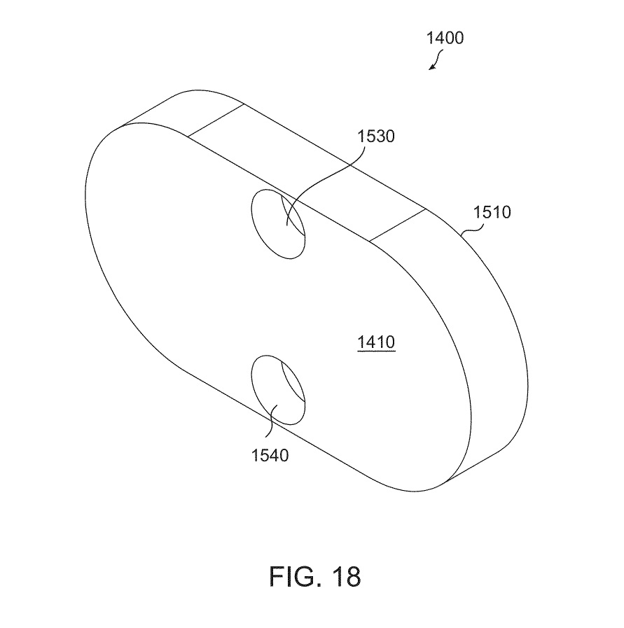

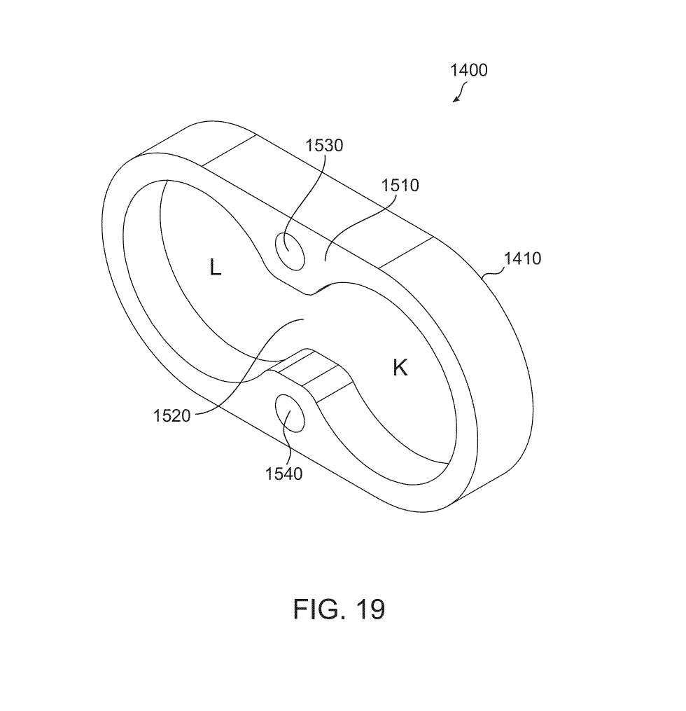

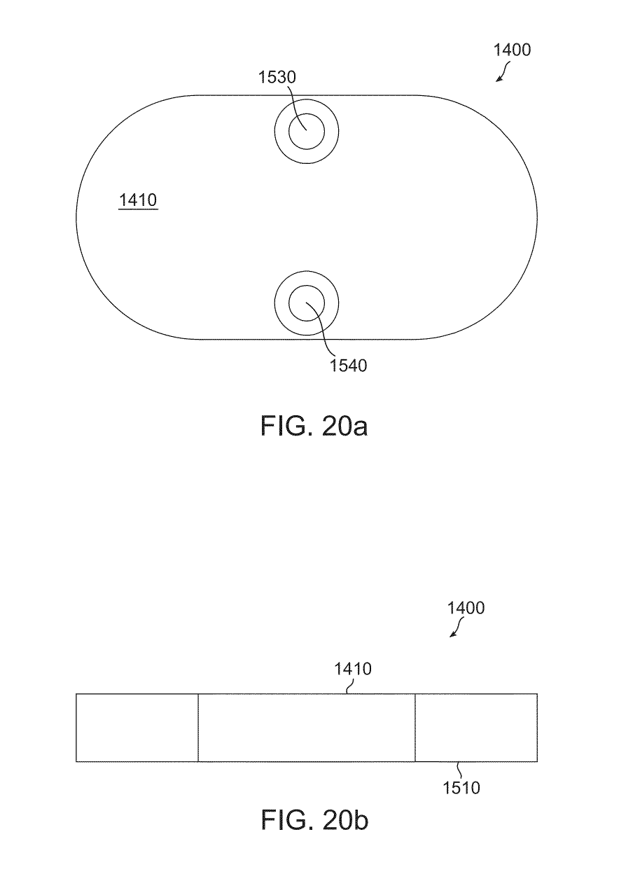

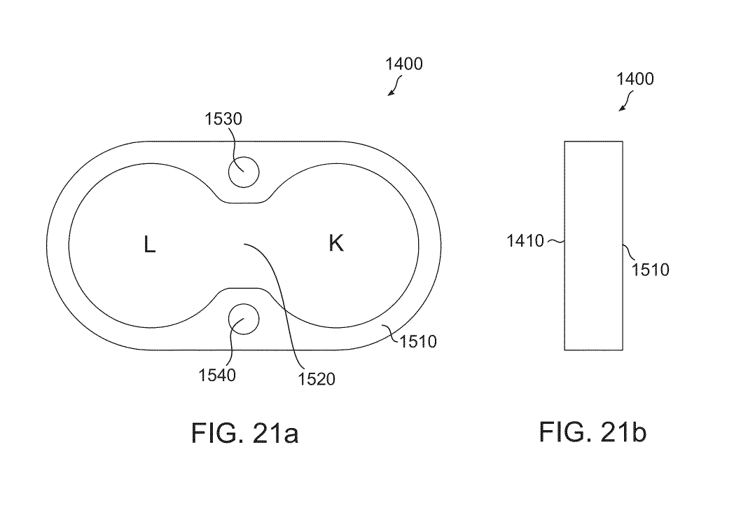

FIGS. 18 and 19 are external perspective views showing the top and bottom, respectively, of the cap 1400 that may be included in the PCV system 1000, in accordance with an embodiment. FIGS. 20a, 20b, 21a, and 21b are an external top view, external side view, external bottom view, and external end view of the cap 1400 of FIGS. 18 and 19. Referring to FIGS. 18 through 21b, the cap 1400 includes a first or top side 1410 and a second or bottom side 1510. The cap 1400 may also include at least two apertures, such as apertures K and L. Apertures K and L may extend through the second or bottom side 1510 of the cap 1400 but may not extend through the top side 1410. Apertures K and L may be respectively aligned and thus mated with the orifices H and I when the cap 1400 is placed against the PCV Plate 1100 such as shown in FIG. 12. Thus, the second or bottom side 1510 of the cap 1400 may be positioned against the first or top side 1110 of the PCV plate 1100 at the raised portion 1120 defining the orifices H and I of the PCV plate 1100. As such, the apertures K and L of the cap 1400 may be coaxially aligned with the orifices H and I of the PCV plate 1100.

The cap 1400 may also include an opening 1520 that extends between the first aperture K and the second aperture L. Thus, the apertures K and L may not be discrete, but may, along with the opening 1520, be formed together such that the apertures K and L and the opening 1520 form one bilobate hole. The two lobes of the bilobate hole, the first aperture K and second aperture L, may thus have a larger maximum width or diameter than that of the opening 1520.

When the cap 1400 is placed against the PCV Plate 1100 (with or without a cap gasket 1600, which is described below, positioned between the cap 1400 and PCV Plate 1100) such that the apertures K and L of the cap 1400 are aligned with the orifices H and I of the PCV Plate, the orifices H and I, the apertures K and L, and the opening 1520 may be in fluid communication. Thus, crankcase fluids including vapors, for example, may flow from orifice H of the PCV plate 1100 to orifice I of the PCV plate 1100 by flowing from orifice H to aperture K of the cap 1400, through the opening 1520 to aperture L of the cap 1400, and through orifice I of the PCV Plate 1100. In that way, the PCV system 1000 can draw crankcase fluids, including vapors, into the intake tract.

In an embodiment, the cap 1400 includes one or more cap attachment points, such as cap fastener holes 1530 and 1540. The cap fastener holes 1530 and 1540 may align with the PCV Plate 1100 holes 1190 and 1192 when the cap 1400 is placed against the PCV Plate 1100 (with or without a cap gasket 1600 positioned between the cap 1400 and PCV Plate 1100). Fasteners 1550 and 1560, which may be screws or other fasteners, may be extended through the cap fastener holes 1530 and 1540 and at least partially into the PCV plate 1110 holes 1190 and 1192 to secure the cap 1400 to the PCV Plate 1100. The PCV plate 1100 holes 1190 and 1192 and cap fastener holes 1530 and 1540 may be threaded if desired. Other means of attachment may be used.

In one embodiment, the PCV system 1000 includes a cap gasket 1600. The cap gasket 1600 may include a first gasket orifice M and a second gasket orifice N. The cap gasket 1600 may be positioned between the PCV Plate 1100 and the cap 1400 such that its orifices M and N are respectively aligned, such as coaxially, with the orifices H and I of the PCV Plate 1100 and the apertures K and L of the cap 1400. The orifices M and N of the cap gasket 1600 may be of similar diameter and shape as the orifices H and I of the PCV plate 1100 and the apertures K and L of the cap 1400 such that, when orifices H and I and apertures K and L are aligned with orifices M and N, respectively, the cap gasket 600 may provide a seal between the cap 1400 and the PCV plate 1100. The cap gasket 1600 may have a profile that matches that of the raised portion 1120 of the PCV plate 1100 and/or the second or bottom side 1510 of the cap 1400. In an embodiment, the cap gasket 1600 may exclude the region that would extend adjacent to the opening 1520 of the cap 1400 when the PCV system 1000 is assembled, and thus exclude the region between the orifices M and N, if desired.

FIG. 22a is an external side view depicting an embodiment of an adapter plug 1900 of the PCV system 1000. FIG. 22b is a cross-sectional view of the adapter plug 1900 along A-A in FIG. 22a. As with the PCV plate 1100 of the PCV system 1000, the adapter plug 1900 may include one or more elements that correspond to those of the adapter plug 900 of the PCV system 10 described herein. Thus, elements 1910, 1920, 1930, 1940, 1950, and 1960 of the adapter plug 1900 may respectively correspond to elements 910, 920, 930, 940, 950, and 960 of the adapter plug 900 described herein. Thus, for example, the adapter plug 1900 may include a first end portion 1910 and a second end portion 1920 and a passage 1960 extending from the first end portion 1910 to the second end portion 1920. Likewise, the first end portion 1910 may include an exterior flange 1930 for connecting to a hose, and the second end portion 1920 may include exterior threads 1950. The exterior flange 1930 may connect to, for example, a block breather hose in which crankcase fluids may be vented to the atmosphere or one or more hoses to a catch can into which crankcase fluids, including liquids and/or vapors, may be discharged. Also, the adapter plug 1900 may connect to the PCV plate 1100 by extending at least partially into one of the orifices H, I, and J of the PCV plate 1100.

However, the adapter plug 1900 may not include the adapter seat such as the adapter seat 970 of the adapter plug 900, if desired.

Also, the second end portion 1920 of the adapter plug 1900 may be tapered (though the second end portion 920 of the adapter plug 900 may be tapered in another embodiment) such that the exterior threads 1950 are tapered threads. In that embodiment, one or more of the orifices H, I, and J may have a similar shape or otherwise be shaped to receive at least part of the tapered second end portion 1920. For example, the orifice J may have a shape that is at least similar to a cone or conical frustum but with its inner wall 1160 having threads that can mate with the exterior threads 1950 that are tapered threads. The adapter plug 1900 in that embodiment may be self-sealing.

Additionally or alternatively to the tapered threads, the adapter plug 1900 in an embodiment may include, as shown in FIGS. 12 and 13, a fastening hole 1980, which may be defined by a tab 1982 if desired or may otherwise be defined by another part of the adapter plug 1900. The tab 1982 may be a projection that projects from the raised portion 1940 or another portion of the adapter plug 1900. The PCV plate 1100 may include a PCV plate hole, which may be the attachment point 1186. The PCV system 1000 may, in this embodiment, include a fastener 1990, which may be a bolt, screw, or another fastener, that extends through the adapter plug 1900 fastening hole 1980 and at least partially into the aforementioned PCV plate 1100 hole, the attachment point 1186. If the fastener 1990 is a screw, the fastener hole 1980 and attachment point 1186 may be threaded. Thus, the attachment point 1186, which is one of the attachment points 1180, 1182, 1184, and 1186 allowing the PCV plate 1100 to be securely installed over ports on a valve cover, may also secure the adapter plug 1900 to the PCV plate 1100. The adapter plug 1900 may include one or more other fastening holes defined by tabs (not shown) for further securing the adapter plug 1900 to the PCV plate 1100, such as via a screw and the attachment point 1184.

As with the PCV system 10, the PCV system 1000 embodiments may be used to ventilate a crankcase. The PCV plate 1100 may having at least two orifices H and I, and possibly another orifice J, may be attached over an engine opening. The cap 1400 having at least two apertures K and L and an opening 1520 between the apertures K and L may be placed on the PCV plate 1100 such that the two apertures K and L align with the PCV plate 1100 orifices H and I. As so aligned, the two PCV plate 1100 orifices H and I, the two apertures J and K of the cap 1400, and the opening 1520 between the apertures J and K may be in fluid communication. Thus, as described herein, crankcase fluids including vapors may flow from orifice H of the PCV plate 1100 to orifice I of the PCV plate 1100 through the first cap 1400 aperture J, the cap 1400 opening 1520, and the second cap 1400 aperture K. In that way, the PCV system 1000 can draw crankcase fluids, including vapors, into the intake tract.

While specific embodiments of the invention have been described in detail, it should be appreciated by those skilled in the art that various modifications and alternations and applications could be developed in light of the overall teachings of the disclosure. For example, in embodiments in which one or both of the link plate plug 700 and adapter plug 900 described herein is threaded, that threading may be tapered in other embodiments. Thus, the portion of one or both of the link plate plug 700 and adapter plug 900 in which the threading is disposed (threading 760 on connecting portion 770 of the link plate plug 700 and threading 950 on second end portion 920 of adapter plug 900) may be tapered. In those embodiments, one or both the link plate plug 700 and adapter plug 900 may thus be self-sealing and may or may not have an adjacently positioned gasket (e.g. gasket adjacent to link plate seat 420 of link plate 400, gasket adjacent to adapter seat 970 of adapter plug 900). Alternatively, the threads 1950 of the adapter plug 1900 may not be tapered such that the second end portion 1920 is not tapered. In that embodiment, one or more of the orifices H, I, and J of the PCV plate 1100 may be shaped to receive at least part of a non-tapered second end portion of the adapter plug 1900 or another adapter plug. Accordingly, the particular arrangements, systems, apparatuses, and methods disclosed are meant to be illustrative only and not limiting as to the scope of the invention.

What is claimed is:

1. A positive crankcase ventilation system, comprising:
a positive crankcase ventilation plate comprising at least two orifices;
a cap comprising at least two apertures and an opening extending between the at least two apertures, the cap for placement against the PCV plate such that at least two of the at least two apertures are aligned with at least two of the at least two PCV plate orifices; and
an adapter plug to connect to the positive crankcase ventilation plate.

2. The positive crankcase ventilation system of claim 1, further comprising a cap gasket including at least two orifices, the cap gasket to be positioned between the positive crankcase ventilation plate and the cap such that the at least two orifices of the cap gasket are aligned with at least two of the at least two orifices of the positive crankcase ventilation plate and are aligned with two of the at least two apertures of the cap.

3. The positive crankcase ventilation system of claim 1, the positive crankcase ventilation plate comprising three orifices, each of the three orifices comprising inner walls, the inner walls threaded.

4. The positive crankcase ventilation system of claim 1, the adapter plug to connect to the positive crankcase ventilation plate by extending at least partially into one of the at least two orifices of the positive crankcase ventilation plate.

5. The positive crankcase ventilation system of claim 1, the adapter plug comprising a first end portion and a second end portion and a passage extending from the first end portion to the second end portion, the first end portion including an exterior flange for connecting to a hose, the second end portion including exterior threads.

6. The positive crankcase ventilation system of claim 5, the second end portion of the adapter plug threaded.

7. The positive crankcase ventilation system of claim 1, the adapter plug comprising an adapter plug fastening hole, the positive crankcase ventilation plate further comprising a positive crankcase ventilation plate hole, and the crankcase ventilation system further comprising a fastener to extend through the adapter plug fastening hole and at least partially into the positive crankcase ventilation plate hole.

8. The positive crankcase ventilation system of claim 1, the positive crankcase ventilation plate further comprising a raised portion defining two of the at least two orifices, the cap for placement against the PCV plate further such that the cap is positioned against the raised portion.

9. The positive crankcase ventilation system of claim 1, the cap comprising two cap fastener holes, the positive crankcase ventilation plate further comprising two positive crankcase ventilation plate holes, and the crankcase ventilation system further comprising two fasteners, each of the two fasteners to extend through one of the two cap fastener holes and at least partially into one of the positive crankcase ventilation plate holes.

10. A positive crankcase ventilation (PCV) system comprising:
a PCV plate comprising a first PCV plate side, a second PCV plate side, a first PCV plate orifice, a second PCV plate orifice, and a third PCV plate orifice;
a cap to be positioned against the PCV plate, the cap comprising a first cap side, a second cap side, a first cap aperture, a second cap aperture, and an opening extending between the first and second cap apertures, the first and second cap apertures to mate at the second cap side with the first and second PCV plate orifices at the first PCV plate side; and
an adapter plug comprising a first end portion, a second end portion, and a passage, the passage extending from the first end portion to the second end portion, the second end portion of the adapter plug to at least partially extend into the third PCV plate orifice to attach the adapter plug to the PCV plate.

11. The PCV system of claim 10, further comprising a cap gasket including a first cap orifice and a second cap orifice, the cap gasket to be positioned between the PCV plate and the cap such that the first and second cap gasket orifices align with the first and second cap apertures and align with the first and second PCV plate orifices.

12. The PCV system of claim 10, the first and second PCV plate orifices defined by a raised portion on the first PCV plate side, the third PCV plate orifice defined by another raised portion on the first PCV plate side.

13. The PCV system of claim 12, the raised portion that defines the first and second PCV plate orifices comprising two threaded PCV plate holes and the cap comprising two threaded cap fastener holes, the PCV system further comprising two screws to each extend through one of the cap fastener holes and at least partially into one of the two threaded PCV plate holes.

14. The PCV system of claim 10, the first, second, and third PCV plate orifices to mate with like openings on a valve cover of an engine.

15. The PCV system of claim 10, the first end portion of the adapter plug comprising an exterior flange to attach to a breather hose, the adapter plug further comprising:
a raised portion extending between the first end portion and the second end portion, the raised portion to receive a wrench head to tighten the adapter plug within the third PCV plate orifice; and
a tab projecting from the raised portion and defining a fastening hole.

16. The PCV system of claim 10, the second end portion of the adapter plug tapered and threaded, one or more of the first PCV plate orifice, second PCV plate orifice, and third PCV plate orifice shaped to receive at least part of the tapered and threaded second end portion of the adapter plug.

17. The PCV system of claim 16, the adapter plug further comprising an adapter plug fastening hole and the PCV plate further comprising a PCV plate hole, the PCV system further comprising a fastener to extend through the adapter plug fastening hole and at least partially into the PCV plate hole to secure the adapter plug to the PCV plate.

18. The PCV system of claim 17, the PCV plate further comprising a plurality of attachment points for attachment to a valve cover, the attachment points including the PCV plate hole.

19. The PCV system of claim 10, the first cap aperture, second cap aperture, and opening extending between the first and second cap apertures form a bilobate hole.

20. A method of ventilating a crankcase, comprising:
attaching a crankcase ventilation plate including at least two orifices over an engine opening; and
placing a cap including at least two apertures and an opening between two of the at least two cap apertures on the positive crankcase ventilation plate such that at least two of the cap apertures are aligned with at least two of the crankcase ventilation plate orifices and such that two of the at least two orifices of the crankcase ventilation plate, the two of the at least two apertures of the cap, and the opening are in fluid communication.
